(19) United States
(12) Patent Application Publication
(10) Pub. No.: US 2017/0116841 A1
(43) Pub. Date: Apr. 27, 2017

(54) METHOD AND DEVICE FOR MONITORING DOOR LOCK STATE

(71) Applicants: LE HOLDINGS (BEIJING) CO., LTD., Beijing (CN); Lemobile Information Technology (Beijing) Co., Ltd., Beijing (CN)

(72) Inventors: Qin HUANG, Beijing (CN); Hailan YU, Beijing (CN)

(21) Appl. No.: 15/236,322

(22) Filed: Aug. 12, 2016

Related U.S. Application Data
(63) Continuation of application No. PCT/CN2016/088402, filed on Jul. 4, 2016.

(30) Foreign Application Priority Data
Oct. 22, 2015 (CN) 201510694421.3
Oct. 22, 2015 (CN) 201510694422.8

(51) Int. Cl. G08B 21/24; E05B 81/64; E05B 47/00

(52) U.S. Cl. CPC G08B 21/24; E05B 47/00; E05B 81/64; E05B 2047/0067

(57) ABSTRACT

Embodiments of the present disclosure disclose a method and a device for monitoring a door lock state. The method specifically comprises searching for a door lock service provided by a server according to a door lock service identification code that is broadcasted by the server and in a corresponding relation to the door lock service, establishing a Bluetooth connection corresponding to the door lock service with the server, and reading a door lock state record characteristic value corresponding to the door lock service by means of the Bluetooth connection according to the door lock service identification code, wherein the door lock state record characteristic value corresponding to the door lock service comprises open or closed. According to the method and the device for monitoring the door lock state, the real-time state of a door lock can be checked by means of a mobile terminal. Hence, compared with the prior art where a user needs to return home to check, the time of the user can be saved and unnecessary economic losses can be avoided.

### CROSS REFERENCE TO RELATED APPLICATIONS

This application is a continuation of International Application No. PCT/CN2016/088402, filed on Jul. 4, 2016, which claims priority to Chinese Patent Application No. 201510694422.8 and 201510694421.3, filed on Oct. 22, 2015, the entire contents of which are incorporated herein by reference.

### FIELD OF TECHNOLOGY

The embodiments of the present disclosure relate to the technical field of wireless communications, and in particular relate to a method and a device for monitoring a door lock state.

### BACKGROUND

With constant development of economy, the people's living standard is increasingly being raised, and more attention is paid to security precautions. However, when a person makes a mistake sometimes, unnecessary trouble may often be caused, and even huge losses are possible.

In people's daily life, the following case may often occur: after leaving home for a while, you are not sure whether the house door is locked. If you return home to check whether the house door is locked, unnecessary trouble may be caused to people and time may be wasted; if you do not, economic losses are possible.

### SUMMARY

Embodiments of the present disclosure disclose a method and device for monitoring a door lock state, which are intended to solve the problem of wasted time or economic losses due to a user, when doubting that the house door is unlocked, needing to return home to check whether the door is locked in the prior art.

The embodiments of the present disclosure provide a method for monitoring a door lock state, including:

searching for a door lock service provided by a server according to a door lock service identification code broadcasted by the server, wherein the door lock service identification code is in a corresponding relation to the door lock service;

establishing a Bluetooth connection corresponding to the door lock service with the server;

reading a door lock state record characteristic value corresponding to the door lock service by means of the Bluetooth connection according to the door lock service identification code, wherein the door lock state record characteristic value corresponding to the door lock service includes open or closed.

According to another aspect of the present disclosure, a method for monitoring a door lock state is provided, which includes:

monitoring a real-time state of a door lock, and updating a door lock state record characteristic value corresponding to a door lock service according to the real-time state of the door lock;

broadcasting a door lock service identification code, wherein the door lock service identification code is in a corresponding relation to the door lock service;

establishing a Bluetooth connection corresponding to the door lock service with a client.

According to further another aspect of the present disclosure, a computing device for monitoring a door lock state is provided, which includes at least one first processor; and a first memory communicably connected with the at least one first processor for storing instructions executable by the at least one first processor, wherein execution of the instructions by the at least one first processor causes the at least one first processor to:

search for a door lock service provided by a server according to a door lock service identification code broadcasted by the server, wherein the door lock service identification code is in a corresponding relation to the door lock service;

establish a Bluetooth connection corresponding to the door lock service with the server; and

read a door lock state record characteristic value corresponding to the door lock service by means of the Bluetooth connection according to the door lock service identification code, wherein the door lock state record characteristic value corresponding to the door lock service includes open or closed.

According to yet another aspect of the present disclosure, a computing device for monitoring a door lock state is provided, which includes at least one second processor; and a second memory communicably connected with the at least one second processor for storing instructions executable by the at least one second processor, wherein execution of the instructions by the at least one second processor causes the at least one second processor to:

monitor a real-time state of a door lock, and update a door lock state record characteristic value corresponding to a door lock service according to the real-time state of the door lock;

broadcast a door lock service identification code, wherein the door lock service identification code is in a corresponding relation to the door lock service; and

establish a Bluetooth connection corresponding to the door lock service with a client.

The embodiments of the present disclosure provide a computing device, which includes one or more processors, a memory, and one or more modules stored in the memory and configured to be executed by the one or more processors, wherein the one or more modules are configured to execute the method described in the embodiments of the present disclosure.

The embodiments of the present disclosure provide a computer readable storage medium on which a program for executing the method described in the embodiments of the present disclosure is stored.

According to the method and device for monitoring the door state provided by the embodiments of the present disclosure, a mobile terminal searches for the door lock service corresponding to the door lock service identification code broadcasted by the server according to the door lock service identification code, and establishes the Bluetooth connection with the server with regard to the door lock service. The door lock state record characteristic value corresponding to the door lock service then can be obtained by means of the Bluetooth connection. That is to say, the real-time state of the door lock can be checked by means of the mobile terminal. Compared with the prior art where a user needs to return home to check, the time of the user can be saved, and unnecessary economic losses can be avoided.

### BRIEF DESCRIPTION OF FIGURES

In order to describe the technical solutions in the embodiments of the present disclosure or the prior art more clearly, accompanying drawings needing to be used in the descriptions of the embodiments or the prior art will be introduced below briefly. It would be obvious that the accompanying drawings in the descriptions below are some embodiments of the present disclosure, and for a person ordinarily skilled in the art, other drawings may also be obtained according to the accompanying drawings without creative labor.

FIG. 1 illustrates a step flow diagram of an embodiment of a method for monitoring a door lock state of the present disclosure.

FIG. 2 illustrates a step flow diagram of another embodiment of a method for monitoring a door lock state of the present disclosure.

FIG. 3 illustrates a step flow diagram of a second embodiment of a method for monitoring a door lock state of the present disclosure.

FIG. 4 illustrates a step flow diagram of another preferred embodiment of a method for monitoring a door lock state of the present disclosure.

FIG. 5 illustrates a step flow diagram of yet another embodiment of a method for monitoring a door lock state of the present disclosure.

FIG. 6 illustrates a step flow diagram of a server in an embodiment of a method for monitoring a door lock state of the present disclosure.

FIG. 7 illustrates a step flow diagram of a server in another embodiment of a method for monitoring a door lock state of the present disclosure.

FIG. 8 illustrates a structural block diagram of an embodiment of a device for monitoring a door lock state of the present disclosure.

FIG. 9 illustrates a structural block diagram of another embodiment of a device for monitoring a door lock state of the present disclosure.

FIG. 10 illustrates a structural block diagram of another preferred embodiment of a device for monitoring a door lock state of the present disclosure.

FIG. 11 illustrates a block diagram of a computing device for executing a method according to the present disclosure.

FIG. 12 illustrates a storage unit for holding or carrying program codes for implementing a method according to the present disclosure.

### DESCRIPTION OF THE EMBODIMENTS

In order to make the objectives, technical solutions and advantages of the embodiments of the present disclosure more clear, the technical solutions in the embodiments of the present disclosure will be described below clearly and completely in conjunction with the accompanying drawings in the embodiments of the present disclosure. Obviously, the described embodiments are part of embodiments of the present disclosure, not all embodiments. On the basis of the embodiments in the present disclosure, all the other embodiments obtained by people ordinarily skilled in the art without creative labor fall into the scope of protection of the present disclosure.

### A First Embodiment

In the embodiments of the present disclosure, a mobile terminal may obtain the real-time state of a monitored apparatus by means of a Bluetooth connection. First, a monitoring device having a Bluetooth function may be installed in the monitored apparatus to monitor and record the real-time state (e.g., open or closed), wherein the monitored apparatus may include a house door, a vehicle door, a window, etc. The specific monitored apparatus is not limited in the present disclosure. Second, the mobile terminal may obtain the real-time state of the monitored apparatus by means of the Bluetooth connection established with the monitored apparatus. Wherein, the mobile terminal may be a cellphone, a smart phone, a laptop computer, a PC (personal computer), an electronic book terminal, a digital broadcast terminal, a PDA (Personal Digital Assistant), a portable multimedia player, a navigation system, or the like. It should be appreciated that the specific mobile terminal is not limited in the embodiments of the present disclosure. For the sake of convenient description, the embodiments of the present disclosure are described with examples where the mobile phone is used as the mobile terminal, and a vehicle and a house door are used as the monitored apparatuses. Other application scenes refer to each other.

BLE (Bluetooth Low Energy) protocol, serving as one part of Bluetooth 4.0 specifications, is introduced to solve the problem of high power consumption of traditional Bluetooth. In the embodiments of the present disclosure, monitoring on the door lock state is realized by means of such characteristics as quick search, quick connection, ultra-low power consumption and the like of BLE. Compared with the use of the traditional Bluetooth, the efficiency of the monitoring efficiency may be improved and energy consumption in the monitoring process may be reduced.

In the BLE protocol, all communications occur at the GATT (Generic Attribute Profile) layer. The BLE protocol may specifically include a GATT client and a GATT server, wherein the GATT server may provide data services for the GATT client, while the GATT client may read and write application data from the GATT server. In communications, the GATT client executes an operation of searching for the GATT server. After the GATT server is found out and a connection is established successfully, the two parties may transmit and receive data. In the embodiments of the present disclosure, the house door may serve as the GATT server to provide the door lock state data service, while the mobile phone may serve as the GATT client to receive the house door state data from the server.

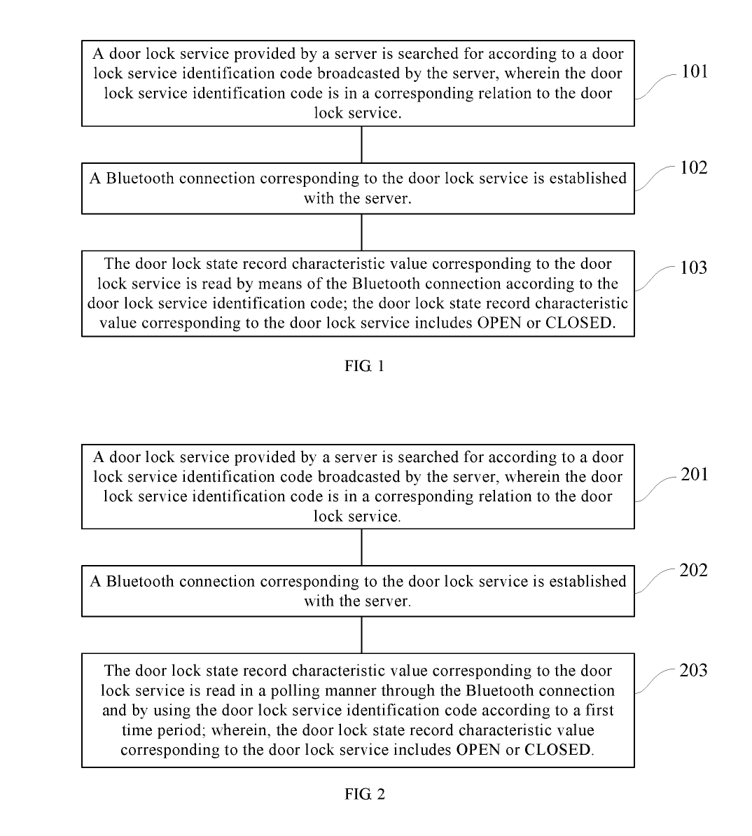

By referring to FIG. 1, illustrated is a step flow diagram of an embodiment of a method for monitoring a door lock state of the present disclosure. The method may specifically include the following steps.

Step 101, a door lock service provided by a server is searched for according to a door lock service identification code broadcasted by the server, wherein the door lock service identification code is in a corresponding relation to the door lock service.

Wherein, the door lock service identification code may be specifically identified by a UUID (Universally Unique Identifier). The UUID may be used to uniquely identify the GATT service.

In specific application, the GATT server may include a plurality of Profiles. Profile may be understood as a specification, and a standard communication protocol. One Profile may include one or more GATT services, each of which indicates that the server may implement one function. Each GATT service may include one or more GATT characteristics, each of which is atomic data capable of being transferred via BLE. One GATT characteristic may include any data, and the type of the any data is expressed by a type identifier. Each GATT characteristic may include zero or more GATT descriptors. One common point of the GATT service, the GATT characteristic, and the GATT descriptor is that they are all identified by using one universally unique identifier (UUID). Just as shown by the name of the UUID, UUID is a simple and unique identifier, and used for find out the GATT service, the GATT characteristic, and the GATT descriptor.

In another application example of the present disclosure, the house door, serving as the GATT server, may provide House door Service, and the characteristic supported by the service may include House door Lock State Record. After the Bluetooth connection is established between the client and the server, the client may obtain the house door service according to the UUID of the house door service, and read the house door lock state record characteristic value corresponding to the house door service.

By referring to Table 1, illustrated is a structure schematic of a Profile of a GATT server of the present disclosure, wherein M represents must, while 0 represent optional. Of course, in actual application, support for the services and characteristics therein can be set as required.

TABLE 1

| Profile Requirement | Support |
|---|---|
| Service Discovery | M |
| House door Service Discovery | M |
| Device Information Service Discovery | O |
| Characteristic Discovery | M |
| House door Service Characteristic Discovery | M |
| Device Information Service Characteristic Discovery | O |
| House door Lock State Record | M |

In this embodiment of the present disclosure, before the Bluetooth connection is established between the client and the server, the service discovery operation and the characteristic discovery operation are executed first. In the stage of Service Discovery, the house door may broadcast the UUID of the service supported by it, i.e., broadcast the UUID of the House Door Service. The mobile phone searches for the corresponding House door Service according to the UUID of the service.

In the stage of Characteristic Discovery, the mobile phone may also discover the characteristic (i.e., House Door Lock State Record characteristic) supported by the service according to the UUID of the House Door Service, as well as the descriptor of the characteristic.

Step 102, a Bluetooth connection corresponding to the door lock service is established with the server.

In the embodiments of the present disclosure, the step of establishing the Bluetooth connection between the client and the server may specifically include:

Step S11, a detection is performed on whether Bluetooth is activated, and if not, a system dialog may pop up to prompt activating Bluetooth.

Step S12, a BLE Bluetooth apparatus (e.g., the house door) is scanned.

Preferably, in order to save energy, the scanning operation may be stopped immediately after a Bluetooth device corresponding to the house door is scanned.

Step S13, a service discovery operation is executed.

In specific application, the service discovery operation may be executed by calling a method BluetoothGatt.discoverServices. The method is asynchronous operation. A search status may be obtained in a callback function onServicesDiscovered. A determination is performed on whether the service discovery operation is successful by determining whether the value of the status is equal to BluetoothGatt.GATT_SUCCESS. If the operation is successful, after the Bluetooth connection is established with the server, the service BluetoothGattService may be obtained through BluetoothGattService.

Step S14, a characteristic discovery operation is executed.

After the service discovery succeeds, the characteristic discovery operation may be executed to obtain specific available characteristic of the above-discovered service. After the Bluetooth connection is established with the server, the characteristic BluetoothGattCharacteristic corresponding to the service may be obtained through BluetoothGattService.getCharacteristic.

Step S15, the Bluetooth connection is established with the server.

In the embodiments of the present disclosure, after the service discovery and characteristic discovery operations are executed completely, the client may establish the Bluetooth connection corresponding to the door lock service with the server, and then carry out reading and writing operations on the door lock state record characteristic value by means of the Bluetooth connection.

Step 103, the door lock state record characteristic value corresponding to the door lock service is read by means of the Bluetooth connection according to the door lock service identification code; the door lock state record characteristic value corresponding to the door lock service includes open or closed.

After the Bluetooth connection is successfully established between the client and the server, a corresponding function may be called to obtain the House door Service of the server, and read and write the House Door Lock State Record characteristic value in the service.

In a preferred embodiment of the present disclosure, the door lock state record characteristic value corresponding to the door lock service may be read through the following step.

The door lock state record characteristic value corresponding to the door lock service is read, in a polling way, according to a first time period.

In actual application, when the distance by which a user leaves the house door is greater than the maximum distance of the Bluetooth connection, the Bluetooth connection between the mobile phone and the house door breaks. In this case, the house door lock state record characteristic value cannot be obtained by means of the mobile phone. The user thus cannot check whether the house door is locked by means of the mobile phone. In order to solve the problem, in the embodiments of the present disclosure, the door lock state record characteristic value corresponding to the door lock service may be read in the polling manner and recorded according to the first time period, wherein the first time period may be set according to actual requirements, for example, 5 seconds. The range of the first time period is not limited in the present disclosure. In this way, the mobile phone already obtains and records the house door lock state record characteristic value in short time after the user leaves the house door, such that the user still can check whether the house door is locked even though the Bluetooth connection breaks. The timeliness of monitoring the house door state thus is ensured.

In conclusion, in the embodiments of the present disclosure, the mobile terminal searches for the door lock service corresponding to the door lock service identification code broadcasted by the server according to the door lock service identification code, and establishes the Bluetooth connection with the server with regard to the door lock service. The house door lock state record characteristic value corresponding to the door lock service then can be obtained by means of the Bluetooth connection. That is to say, the real-time state of the door lock can be checked by means of the mobile terminal. Compared with the prior art where a user needs to return home to check, the time of the user can be saved, and unnecessary economic losses can be avoided.

Besides, in the embodiments of the present disclosure, the door lock state record characteristic value corresponding to the door lock service is read, in the polling way, according to the first time period, thereby avoiding the problem that the door lock state record characteristic value corresponding to the door lock service cannot be obtained due to broken Bluetooth connection. As a result, the timeliness of monitoring the door lock state can be guaranteed.

In the embodiments of the present disclosure, a vehicle may serve as the GATT server to provide the door lock state data service, while a mobile phone may serve as the GATT client to receive vehicle door state data from the server. Hence, the embodiments of the present disclosure may also employ the following step process.

By referring to FIG. 2, illustrated is a step flow diagram of another embodiment of a method for monitoring a door lock state of the present disclosure. The method may specifically include the following steps: Step 201, a door lock service provided by a server is searched for according to a door lock service identification code broadcasted by the server, wherein the door lock service identification code is in a corresponding relation to the door lock service.

In another application example of the present disclosure, the vehicle serving as the GATT server may provide House door Service, and the characteristic supported by the service may include House door Lock State Record. After a Bluetooth connection is established between the client and the server, the client may obtain the House door Service according to the UUID of the House door Service, and read the vehicle door lock state record characteristic value corresponding to the House door Service.

By referring to Table 2, illustrated is a structure schematic of a Profile of a GATT server of the present disclosure, wherein M represents must, while 0 represent optional. Of course, in actual application, support for the services and characteristics therein can be set as required.

TABLE 2

| Profile Requirement | Support |
|---|---|
| Service Discovery | M |
| House door Service Discovery | M |
| Device Information Service Discovery | O |
| Characteristic Discovery | M |
| House door Service Characteristic Discovery | M |
| Device Information Service Characteristic Discovery | O |
| House door Lock State Record | M |

In this embodiment of the present disclosure, before the Bluetooth connection is established between the client and the server, the service discovery operation and the characteristic discovery operation are executed first. In the stage of Service Discovery, the server (a Bluetooth device on the vehicle) may broadcast the UUIDs of the services supported by it, which specifically may include the UUID of Vehicle door Service, the UUID of Vehicle window Service, and the UUID of Vehicle trunk Service. The mobile phone searches for the corresponding Vehicle door Service, Vehicle window Service and Vehicle trunk Service according to the UUIDs of the above services.

In the stage of Characteristic Discovery, the mobile phone may also discover the Vehicle door State Record characteristic supported by the service according to the UUID of Vehicle door Service, the Vehicle window State Record characteristic supported by the service according to the UUID of Vehicle window Service, and the Vehicle trunk State Record characteristic supported by the service according to the UUID of Vehicle trunk Service, and descriptors corresponding to the above characteristics.

Step 202, the Bluetooth connection corresponding to the door lock service is established with the server.

The step 202 is similar to the step 102 in the above embodiment corresponding to FIG. 1. Hence, in this embodiment, the step of establishing the Bluetooth connection between the client and the server also includes steps S11 to step S15, which are not redundantly described herein. Please see the above embodiment for details.

Step 203, the door lock state record characteristic value corresponding to the door lock service is read in a polling manner through the Bluetooth connection and by using the door lock service identification code according to a first time period; wherein, the door lock state record characteristic value corresponding to the door lock service includes open or closed.

After the Bluetooth connection is successfully established between the client and the server, a corresponding function may be called to obtain the House door Service of the server, and read and write the House Door Lock State Record characteristic value in the service.

In actual application, when the distance by which a user leaves the vehicle door is greater than the maximum distance of the Bluetooth connection, the Bluetooth connection between the mobile phone and the vehicle breaks. In this case, the vehicle door lock state record characteristic value cannot be obtained by means of the mobile phone. The user thus cannot check whether the vehicle door is locked by means of the mobile phone. In order to solve the problem, in the embodiments of the present disclosure, the door lock state record characteristic value corresponding to the door lock service may be read in the polling manner and recorded according to the first time period, wherein the first time period may be set according to actual requirements, for example, 5 seconds. The range of the first time period is not limited in the present disclosure. In this way, the mobile phone already obtains and records the vehicle door lock state record characteristic value in short time after the user leaves the vehicle door, such that the user still can check whether the vehicle door is locked even though the Bluetooth connection breaks. The timeliness of monitoring the vehicle door state thus is ensured.

In conclusion, in the embodiments of the present disclosure, the mobile terminal searches for the door lock service corresponding to the door lock service identification code broadcasted by the server according to the door lock service identification code, and establishes the Bluetooth connection with the server with regard to the door lock service. The door lock state record characteristic value corresponding to the door lock service then can be periodically obtained at the client by means of the Bluetooth connection. The real-time state of the vehicle door thus can be obtained immediately. Compared with the prior art where a user needs to return to check, the time of the user can be saved, and unnecessary economic losses can be avoided. Further, in one above embodiment of the present disclosure, the door lock state record characteristic value corresponding to the door lock service is read, in the polling way, according to the first time period, thereby avoiding the problem that the door lock state record characteristic value corresponding to the door lock service cannot be obtained due to broken Bluetooth connection. As a result, the timeliness of monitoring the door lock state can be guaranteed.

### A Second Embodiment

This embodiment may also include the following optional technical solutions on the basis of the above first embodiment. According to this embodiment, after the Bluetooth connection is established between the client and the server, a distance between the client and the server may be monitored. When the distance is greater than a first threshold and the door lock state record characteristic value is open, reminding information is sent to remind the user of the house door being unlocked. In this way, the economic losses of the user can be avoided.

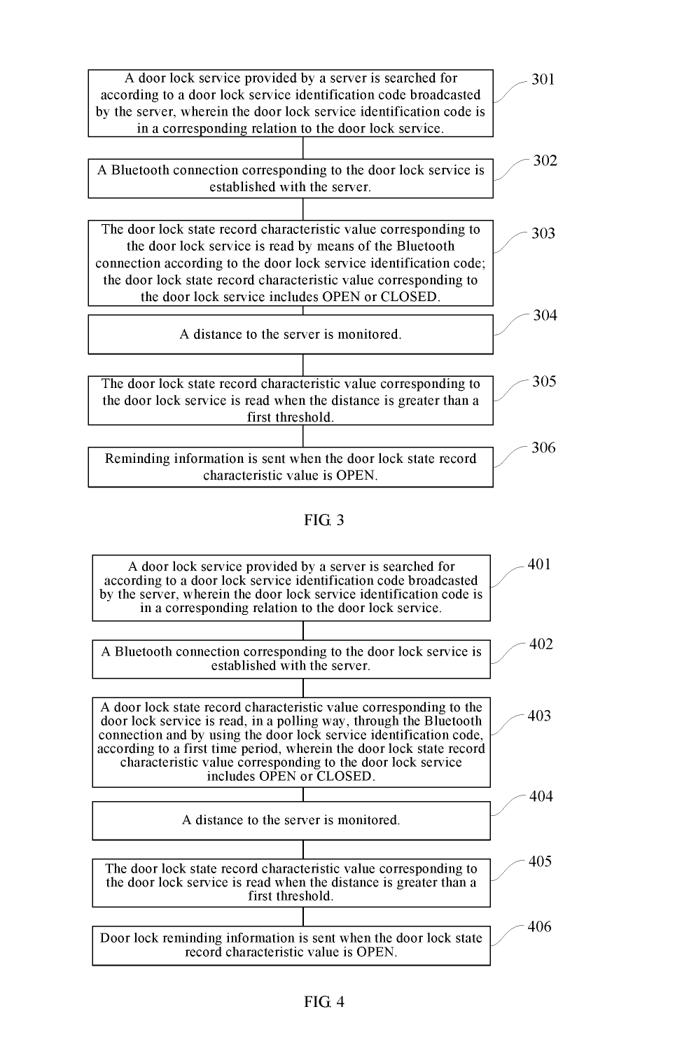

By referring to FIG. 3, illustrated is a step flow diagram of a second embodiment of a method for monitoring a door lock state of the present disclosure. The method may specifically include the steps as follows.

Step 301, a door lock service provided by a server is searched for according to a door lock service identification code broadcasted by the server, wherein the door lock service identification code is in a corresponding relation to the door lock service.

Step 302, a Bluetooth connection corresponding to the door lock service is established with the server.

Step 303, the door lock state record characteristic value corresponding to the door lock service is read by means of the Bluetooth connection according to the door lock service identification code; the door lock state record characteristic value corresponding to the door lock service includes open or closed.

Step 304, a distance to the server is monitored.

Step 305, the door lock state record characteristic value corresponding to the door lock service is read when the distance is greater than a first threshold.

Step 306, reminding information is sent when the door lock state record characteristic value is open.

In specific application, the distance that a user is away from a house door can be obtained by monitoring the distance to the server. If the distance is greater than the first threshold, it indicates that the user is already much far from home. If the read door lock state record characteristic value is open, the reminding information may be sent to the user to inform the user of the house door being unlocked. Wherein, the first threshold may be set to a corresponding distance value greater than 0 and small than the maximum range of the Bluetooth connection, for example, 20 m. The numerical area of the first threshold is not limited in the present disclosure.

In a preferred embodiment of the present disclosure, the above steps 304-306 may also be replaced by the steps of monitoring the signal strength of the Bluetooth connection, and determining the path loss of the Bluetooth connection according to the signal strength, reading the door lock state record characteristic value corresponding to the door lock service when the path loss is greater than a second threshold, and sending reminding information when the door lock state record characteristic value is open.

In specific application, in addition to the above method of monitoring the distance, the distance between the client and the server may also be determined according to the path loss of the Bluetooth connection. Specifically, after the Bluetooth connection is established between the client and the server, the mobile phone may monitor the RSSI (Received Signal Strength Indicator) of the Bluetooth connection, read transmitting power from the server, and calculate the path loss by subtracting the RSSI from the transmitting power. When the path loss is greater than the second threshold, it indicates that the user is already much far from home. If the read door lock state record characteristic value is open, reminding information may be sent to the user to inform the user of the house door being unlocked. Wherein, the second threshold may be set to a corresponding path loss value greater than 0 and small than the maximum range of the Bluetooth connection. The numerical area of the second threshold is not limited in the present disclosure.

In another preferred embodiment of the present disclosure, the above method may also include the step of:

closing the door lock by means of the Bluetooth connection with regard to a door closing operation executed by a user according to the reminding information, and modifying the door lock state record characteristic value corresponding to the door lock service to closed.

In conclusion, according to the embodiments of the present disclosure and on the basis of the above first embodiment, the distance between the client and the server may also be monitored. When the distance is greater than the first threshold and the door lock state record characteristic value is open, the reminding information is sent to remind the user of the house door being unlocked when the user is not far away from home. The economic losses of the user can thus be avoided.

On the basis of the above embodiments, the following optional technical solution may also be included. According to the present embodiment, after the Bluetooth connection between the client and the server is established, the distance between the client and the server may be monitored. When the distance is greater than the first threshold and the door lock state record characteristic value is open, the reminding information is sent to remind the user of the vehicle door being unlocked. The economic losses of the user can thus be avoided.

By referring to FIG. 4, illustrated is a step flow diagram of another preferred embodiment of a method for monitoring a door lock state of the present disclosure. The method may specifically include the steps as follows.

Step 401, a door lock service provided by a server is searched for according to a door lock service identification code broadcasted by the server, wherein the door lock service identification code is in a corresponding relation to the door lock service.

Step 402, a Bluetooth connection corresponding to the door lock service is established with the server.

Step 403, a door lock state record characteristic value corresponding to the door lock service is read, in a polling way, through the Bluetooth connection and by using the door lock service identification code, according to a first time period, wherein the door lock state record characteristic value corresponding to the door lock service includes open or closed.

Step 404, a distance to the server is monitored.

Step 405, the door lock state record characteristic value corresponding to the door lock service is read when the distance is greater than a first threshold.

Step 406, door lock reminding information is sent when the door lock state record characteristic value is open.

Similar to the above embodiment, in specific application, the distance that a user is away from a vehicle can be obtained by monitoring the distance to the server. If the distance is greater than the first threshold, it indicates that the user is already much far from the vehicle. If the read door lock state record characteristic value is open, the door lock reminding information may be sent to the user to inform the user of the vehicle door being unlocked. Wherein, the first threshold may be set to a corresponding distance value greater than 0 and small than the maximum range of the Bluetooth connection, for example, 20 m. The numerical area of the first threshold is not limited in the present disclosure.

In a preferred embodiment of the present disclosure, the above steps 404-406 may also be replaced by the steps of monitoring the signal strength of the Bluetooth connection, and determining the path loss of the Bluetooth connection according to the signal strength, reading the door lock state record characteristic value corresponding to the door lock service when the path loss is greater than a second threshold, and sending door lock reminding information when the door lock state record characteristic value is open.

In specific application, in addition to the above method of monitoring the distance, the distance between the client and the server may also be determined according to the path loss of the Bluetooth connection. Specifically, after the Bluetooth connection is established between the client and the server, the mobile phone may monitor the RSSI (Received Signal Strength Indicator) of the Bluetooth connection, read transmitting power from the server, and calculate the path loss by subtracting the RSSI from the transmitting power. When the path loss is greater than the second threshold, it indicates that the user is already much far from the vehicle. If the read door lock state record characteristic value is open, door lock reminding information may be sent to the user. Wherein, the second threshold may be set to a corresponding path loss value greater than 0 and small than the maximum range of the Bluetooth connection. The numerical area of the second threshold is not limited in the present disclosure.

In another preferred embodiment of the present disclosure, the above method may also include the step of:

closing the door lock by means of the Bluetooth connection with regard to a door closing operation executed by a user according to the reminding information, and modifying the door lock state record characteristic value corresponding to the door lock service to closed.

In conclusion, according to the embodiments of the present disclosure and on the basis of the above first embodiment, the distance between the client and the server may also be monitored. When the distance is greater than the first threshold and the door lock state record characteristic value is open, the reminding information is sent to remind the user of the vehicle door being unlocked when the user is not far away from the vehicle. The economic losses of the user can thus be avoided.

On the basis of the above first embodiment or second embodiment, the present embodiment may also include the following optional technical solution. According to the present embodiment, the state of the vehicle window may be further monitored when detecting that the vehicle door is locked.

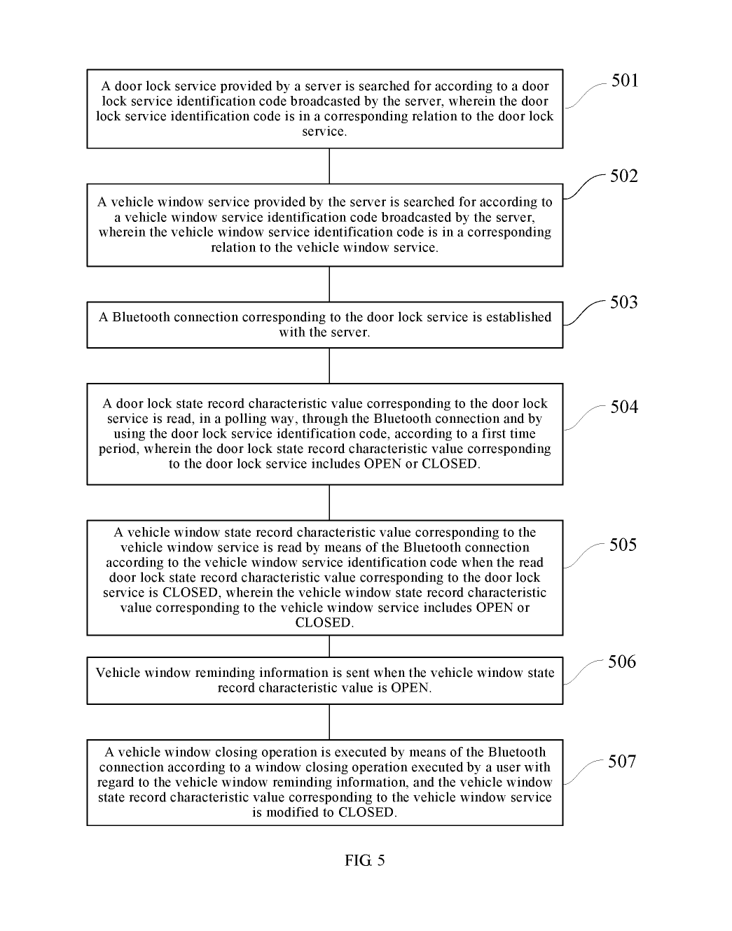

By referring to FIG. 5, illustrated is a step flow diagram of yet another embodiment of a method for monitoring a door lock state of the present disclosure. The method may specifically include the following steps.

Step 501, a door lock service provided by a server is searched for according to a door lock service identification code broadcasted by the server, wherein the door lock service identification code is in a corresponding relation to the door lock service.

Step 502, a vehicle window service provided by the server is searched for according to a vehicle window service identification code broadcasted by the server, wherein the vehicle window service identification code is in a corresponding relation to the vehicle window service.

Step 503, a Bluetooth connection corresponding to the door lock service is established with the server.

Step 504, a door lock state record characteristic value corresponding to the door lock service is read, in a polling way, through the Bluetooth connection and by using the door lock service identification code, according to a first time period, wherein the door lock state record characteristic value corresponding to the door lock service includes open or closed.

Step 505, a vehicle window state record characteristic value corresponding to the vehicle window service is read by means of the Bluetooth connection according to the vehicle window service identification code when the read door lock state record characteristic value corresponding to the door lock service is closed, wherein the vehicle window state record characteristic value corresponding to the vehicle window service includes open or closed.

Step 506, vehicle window reminding information is sent when the vehicle window state record characteristic value is open.

In a preferred embodiment of the present disclosure, the method may also include:

step 507, a vehicle window closing operation is executed by means of the Bluetooth connection according to a window closing operation executed by a user with regard to the vehicle window reminding information, and the vehicle window state record characteristic value corresponding to the vehicle window service is modified to closed.

By using a similar method, the real-time state of a vehicle trunk may also be monitored after the user locks the vehicle door. This process may refer to the process of monitoring the vehicle window, which is not redundantly described herein.

In actual application, the case that a user may possibly forget to close one vehicle window after locking the vehicle door may often happen. According to the embodiments of the present disclosure, when the read door lock state record characteristic value is closed, it can be known that the user closes the vehicle door and is ready to leave. At this moment, the vehicle window state record characteristic value is read by the mobile phone through the Bluetooth connection. If the vehicle window state record characteristic value is open, the vehicle window reminding information is sent to the user to remind the user of closing the vehicle window. The economic losses of the user can thus be avoided.

### A Third Embodiment

The above first and second embodiments both are described by taking the client side as the example. The method for monitoring the door lock state of the present disclosure will be described on the server side.

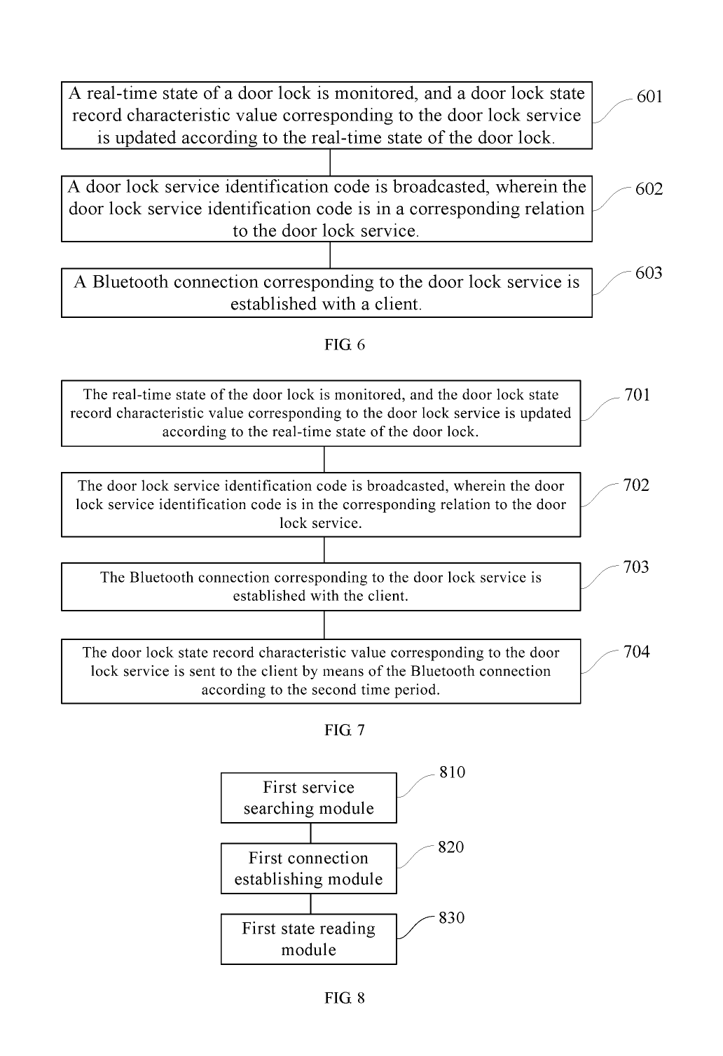

By referring to FIG. 6, illustrated is a step flow diagram of a server in an embodiment of a method for monitoring a door lock state of the present disclosure. The flow may specifically include the steps as follows.

Step 601, a real-time state of a door lock is monitored, and a door lock state record characteristic value corresponding to the door lock service is updated according to the real-time state of the door lock.

Specifically, the step of monitoring the real-time state of the door lock, and updating the door lock state record characteristic value corresponding to the door lock service according to the real-time state of the door lock may specifically include

monitoring the real-time state of the door lock, and updating the door lock state record characteristic value corresponding to the door lock service when the real-time state of the door lock is changed from open to closed, or from closed to open.

Step 602, a door lock service identification code is broadcasted, wherein the door lock service identification code is in a corresponding relation to the door lock service.

In actual application, the server (e.g., a house door) may broadcast the door lock service identification code, such that a client may search for the door lock service according to the door lock service identification code, and obtain the door lock state record characteristic value corresponding to the door lock service.

Step 603, a Bluetooth connection corresponding to the door lock service is established with a client.

After the Bluetooth connection is established with the client, the client may read the door lock state record characteristic value corresponding to the door lock service according to the door lock service identification code by means of the Bluetooth connection.

In a preferred embodiment of the present disclosure, the above method may also include:

sending the door lock state record characteristic value corresponding to the door lock service to the client by means of the Bluetooth connection according to a second time period.

In specific application, the server may periodically send the door lock state record characteristic value to the client in the way of notification. In this way, the client may not need to periodically read, in a polling manner, data from the server.

### Application Example 1

Precondition: a mobile phone is already in connection with a house door by means of BLE, and a user walks out of the house door and forgets to lock the door.

Step S21, the server (i.e., the house door) monitors the real-time state of the door lock. At this moment, the door lock is in an open state, and therefore, the door lock state record characteristic value corresponding to the door lock service is updated to open.

Step S22, the client (i.e., the mobile phone) monitors a distance to the server, and when the distance is greater than 5 m, the door lock state record characteristic value corresponding to the door lock service is read, which is open.

Step S23, the mobile phone sends the reminding information to the user to remind the user of locking the door.

### Application Example 2

Precondition: a mobile phone is already in connection with a house door by means of BLE, and a user walks out of the house door and closes the house door.

Step S31, the server (i.e., the house door) monitors the real-time state of the door lock. At this moment, the door lock is in a closed state, and therefore, the door lock state record characteristic value corresponding to the door lock service is updated to closed.

Step S32, the user has a doubt on forgetting to lock the door on the point of walking out of the residential area, and then may check the house door lock state information using the mobile phone. Specifically, the client (i.e., the mobile phone) reads, by means of the Bluetooth connection, the door lock state record characteristic value corresponding to the door lock service, which is closed.

In conclusion, the server in the embodiments of the present disclosure may monitor and record the real-time state of the door lock, and broadcast the door lock service identification code, such that the client may discover the door lock service according to the door lock service identification code, and establish the Bluetooth connection to obtain the door lock state record characteristic value. That is to say, the real-time state of the door lock can be checked by means of the mobile terminal. Compared with the prior art where the user needs to return home to check, the time of the user can be saved and unnecessary economic losses can be avoided.

On the basis of the above embodiment, the server in the present embodiment may also involve the following flow as shown in FIG. 7.

By referring to FIG. 7, illustrated is a step flow diagram of a server in another embodiment of a method for monitoring a door lock state of the present disclosure. The flow may specifically include the steps as follows.

Step 701, the real-time state of the door lock is monitored, and the door lock state record characteristic value corresponding to the door lock service is updated according to the real-time state of the door lock.

Specifically, the step of monitoring the real-time state of the door lock, and updating the door lock state record characteristic value corresponding to the door lock service according to the real-time state of the door lock may specifically include monitoring the real-time state of the door lock, and updating the door lock state record characteristic value corresponding to the door lock service when the real-time state of the door lock is changed from open to closed, or from closed to open.

Step 702, the door lock service identification code is broadcasted, wherein the door lock service identification code is in the corresponding relation to the door lock service.

In actual application, the server may broadcast the door lock service identification code, such that the client may search for the door lock service according to the door lock service identification code, and obtain the door lock state record characteristic value corresponding to the door lock service.

Step 703, the Bluetooth connection corresponding to the door lock service is established with the client.

After the Bluetooth connection is established with the client, the client may read the door lock state record characteristic value corresponding to the door lock service according to the door lock service identification code by means of the Bluetooth connection.

Step 704, the door lock state record characteristic value corresponding to the door lock service is sent to the client by means of the Bluetooth connection according to the second time period.

In specific application, the server may periodically send the door lock state record characteristic value to the client in the way of notification. In this way, the client may not need to periodically read, in a polling manner, data from the server.

In a preferred embodiment of the present disclosure, the above method may also include monitoring a real-time state of a vehicle window, updating a vehicle window state record characteristic value corresponding to a vehicle window service according to the real-time state of the vehicle window, and broadcasting a vehicle window service identification code, wherein the vehicle window service identification code is in a corresponding relation to the vehicle window service.

### Application Example 3

Precondition: a mobile phone is already in connection with a vehicle by means of BLE, and a user leaves the seat, closes and locks the vehicle door, but forgets to close the vehicle window on the passenger seat side.

Step S41, the server (i.e., a Bluetooth device on the vehicle) monitors the real-time state of the door lock. At this moment, the door lock is in a closed state, and therefore, the door lock state record characteristic value corresponding to the door lock service is updated to closed.

Step S42, the server (i.e., THE Bluetooth device on the vehicle) monitors the real-time state of the vehicle window. At this moment, the vehicle window is in an open state, and therefore, the vehicle window state record characteristic value corresponding to the vehicle window service is updated to open.

Step S43, the client (i.e., the mobile phone) reads out that the door lock state record characteristic value is closed by means of the Bluetooth connection according to the door lock service identification code.

Step 44, the client reads, by means of the Bluetooth connection and according to the vehicle window service identification code, the vehicle window state record characteristic value, which is open.

Step S45, the client sends vehicle window reminding information to the user to remind the user of closing the vehicle window.

In conclusion, the server in the embodiments of the present disclosure may monitor and record the real-time state of the door lock, and broadcast the door lock service identification code, such that the client may discover the door lock service according to the door lock service identification code, and establish the Bluetooth connection to obtain the door lock state record characteristic value. Moreover, in the embodiments of the present disclosure, the door lock state record characteristic value corresponding to the door lock service is sent to the client by means of the Bluetooth connection according to the second time period. That is to say, the real-time state of the door lock can be checked by means of the mobile terminal. Compared with the prior art where the user needs to return home to check, the time of the user can be saved and unnecessary economic losses can be avoided.

### First Device Embodiment

By referring to FIG. 8, illustrated is a structural block diagram of an embodiment of a device for monitoring a door lock state of the present disclosure. The device may specifically include:

a first service searching module 810, configured to search for a door lock service provided by a server according to a door lock service identification code broadcasted by the server, wherein the door lock service identification code is in a corresponding relation to the door lock service;

a first connection establishing module 820, configured to establish a Bluetooth connection corresponding to the door lock service with the server; and

a first state reading module 830, configured to read a door lock state record characteristic value corresponding to the door lock service by means of the Bluetooth connection according to the door lock service identification code, wherein the door lock state record characteristic value corresponding to the door lock service includes open or closed.

In another optional embodiment, a first state reading module 530 is configured to, according to a first time period, read, in a polling way, the door lock state record characteristic value corresponding to the door lock service through the Bluetooth connection and by using the door lock service identification code, wherein the door lock state record characteristic value corresponding to the door lock service includes open or closed.

In a preferred embodiment of the present disclosure, the device may also include:

a first distance monitoring module, configured to monitor a distance to the server;

a second state reading module, configured to read the door lock state record characteristic value corresponding to the door lock service when the distance is greater than a first threshold;

a first reminding module, configured to send reminding information when the door lock state record characteristic value is open. Wherein, the reminding information includes door lock reminding information. Specifically, the first reminding module is configured to send the door lock reminding information when the door lock state record characteristic value is open.

In another preferred embodiment of the present disclosure, the device may also include:

a second distance monitoring module, configured to monitor signal strength of the Bluetooth connection, and determine path loss of the Bluetooth connection according to the signal strength;

a third state reading module, configured to read the door lock state record characteristic value corresponding to the door lock service when the path loss is greater than a second threshold;

a second reminding module, configured to send reminding information when the door lock state record characteristic value is open. Moreover, the second reminding module is configured to send the door lock reminding information when the door lock state record characteristic value is open.

In yet another preferred embodiment of the present disclosure, the first state reading module 430 may specifically include:

a first state reading submodule, configured to read, in a polling way, the door lock state record characteristic value corresponding to the door lock service according to a first time period.

In further another preferred embodiment of the present disclosure, the device may also include:

a first state modifying module, configured to execute a door lock closing operation by means of the Bluetooth connection according to a door closing operation executed by a user with regard to the reminding information, and modify the door lock state record characteristic value corresponding to the door lock service to closed. Moreover, the first state modifying module is configured to execute the door lock closing operation by means of the Bluetooth connection according to the door closing operation executed by the user with regard to the door lock reminding information, and modify the door lock state record characteristic value corresponding to the door lock service to closed.

In further another preferred embodiment of the present disclosure, the device may also include:

a second service searching module, configured to search for a vehicle window service provided by the server according to a vehicle window service identification code broadcasted by the server, wherein the vehicle window service identification code is in a corresponding relation to the vehicle window service;

a fourth state reading module, configured to read a vehicle window state record characteristic value corresponding to the vehicle window service by means of the Bluetooth connection according to the vehicle window service identification code when the read door lock state record characteristic value corresponding to the door lock service is closed, wherein the vehicle window state record characteristic value corresponding to the vehicle window service includes open or closed;

a third reminding module, configured to send vehicle window reminding information when the vehicle window state record characteristic value is open.

In further another preferred embodiment of the present disclosure, the device may also include:

a second state modifying module, configured to execute a vehicle window closing operation by means of the Bluetooth connection according to a window closing operation executed by a user with regard to the vehicle window reminding information, and modify the vehicle window state record characteristic value corresponding to the vehicle window service to closed.

### A Second Device Embodiment

By referring to FIG. 9, illustrated is a structural block diagram of another embodiment of a device for monitoring a door lock state of the present disclosure. the device may specifically include:

a state monitoring module 910, configured to monitor a real-time state of a door lock, and update a door lock state record characteristic value corresponding to a door lock service according to the real-time state of the door lock;

a broadcasting module 920, configured to broadcast a door lock service identification code, wherein the door lock service identification code is in a corresponding relation to the door lock service; and a second connection establishing module 930, configured to establish a Bluetooth connection corresponding to the door lock service with a client.

In a preferred embodiment of the present disclosure, the state monitoring module 510 may specifically include:

a state monitoring submodule, configured to monitor the real-time state of the door lock, and update the door lock state record characteristic value corresponding to the door lock service when the real-time state of the door lock is changed from open to closed, or from closed to open.

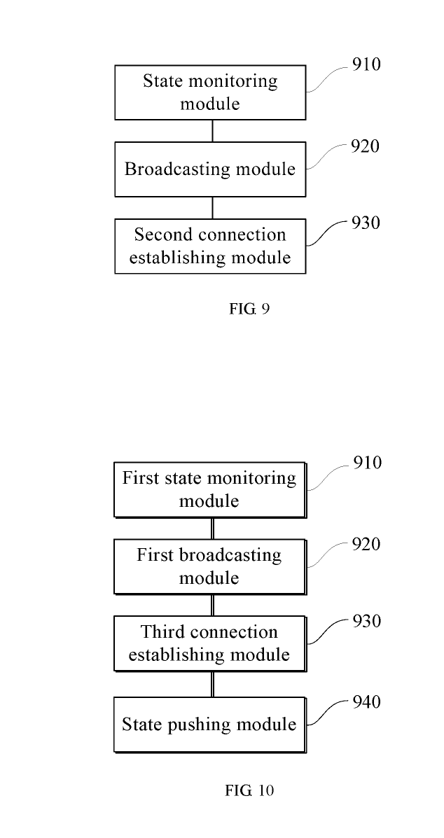

In another preferred embodiment of the present disclosure, as shown in FIG. 10, the following modules may be included:

a first state monitoring module 910, configured to monitor a real-time state of a door lock, and update a door lock state record characteristic value corresponding to a door lock service according to the real-time state of the door lock;

a first broadcasting module 920, configured to broadcast a door lock service identification code, wherein the door lock service identification code is in a corresponding relation to the door lock service;

a second connection establishing module 930, configured to establish a Bluetooth connection corresponding to the door lock service with a client; and

a state pushing module 940, configured to send the door lock state record characteristic value corresponding to the door lock service to the client by means of the Bluetooth connection according to a second time period.

In another preferred embodiment of the present disclosure, the device may also include:

a second state monitoring module, configured to monitor a real-time state of a vehicle window, and update a vehicle window state record characteristic value corresponding to a vehicle window service according to the real-time state of the vehicle window;

a second broadcasting module, configured to broadcast a vehicle window service identification code, wherein the vehicle window service identification code is in a corresponding relation to the vehicle window service.

For the device embodiments, as they are substantially similar to the method embodiments, the descriptions are relatively simple; for the relevant parts, just see part of descriptions of the method embodiments.

The device embodiments described above are merely exemplary, wherein units described as separate parts may be or not separated physically, and parts displayed as units may be or not physical units, which may be located at the same place, or may also be distributed on a plurality of network units. Partial or all modules therein may be selected according to actual requirements to achieve the objectives of the solutions of the present embodiments. The solutions can be understood and implemented by a person ordinarily skilled in the art without creative labor.

The various device embodiments of the present disclosure may be implemented by hardware, or implemented by software modules running on one or more processors, or by combination therefore. It should be appreciated by a person skilled in the art that some or all functions or some or all components in communication processing equipment according to the embodiments of the present disclosure may be implemented by using a microprocessor or a digital signal processor (DSP) in practice. The present disclosure may also be implemented as equipment or device programs (e.g., computer programs and computer program products) for executing one part or all of the method described herein. Such programs for implementing the present disclosure may be stored on a computer readable medium, or may be in the form or one or more signals. Such signals may be downloaded from Internet websites, or provided on carrier signals, or provided in any other forms.

For example, the device of the present disclosure can be applied to a server that traditionally may include a processor, and a computer program product in the form of a memory or a computer readable medium. The memory may be an electronic memory, such as a flash memory, an EEPROM (Electrically-Erasable Programmable ROM), an EPROM, a hard disk or an ROM. The memory is provided with a storage space for program codes for executing any method steps in the above method. For example, the storage space for the program codes may include various program codes for separately implementing various steps in the above method. The program codes may be read out from one or more computer program products or written into the one or more computer program products. The computer program products include program code carriers such as a hard disk, a compact disk (CD), a memory card or a soft disk. Such computer program products typically are portable or fixed storage units, which may have storage sections, storage spaces and the like arranged in a way similar to that of the memory in the above server. The program codes may be compressed in an appropriate form. Typically, the storage unit includes computer readable codes, namely codes that can be read by, for example, the above processor. When the server runs the codes, the server is led to execute various steps in the method described above.

It should be appreciated by a person ordinarily skilled in the art that the implementation of all or part of steps of the above method embodiments may be completed by means of program command related hardware. The above programs may be stored in a computer readable storage medium. When the programs are executed, the steps of the above method embodiments also are executed. Moreover, the above storage medium includes various mediums capable of storing the program codes, such as a ROM, a RAM, a magnetic disk, an optical disk, and the like.

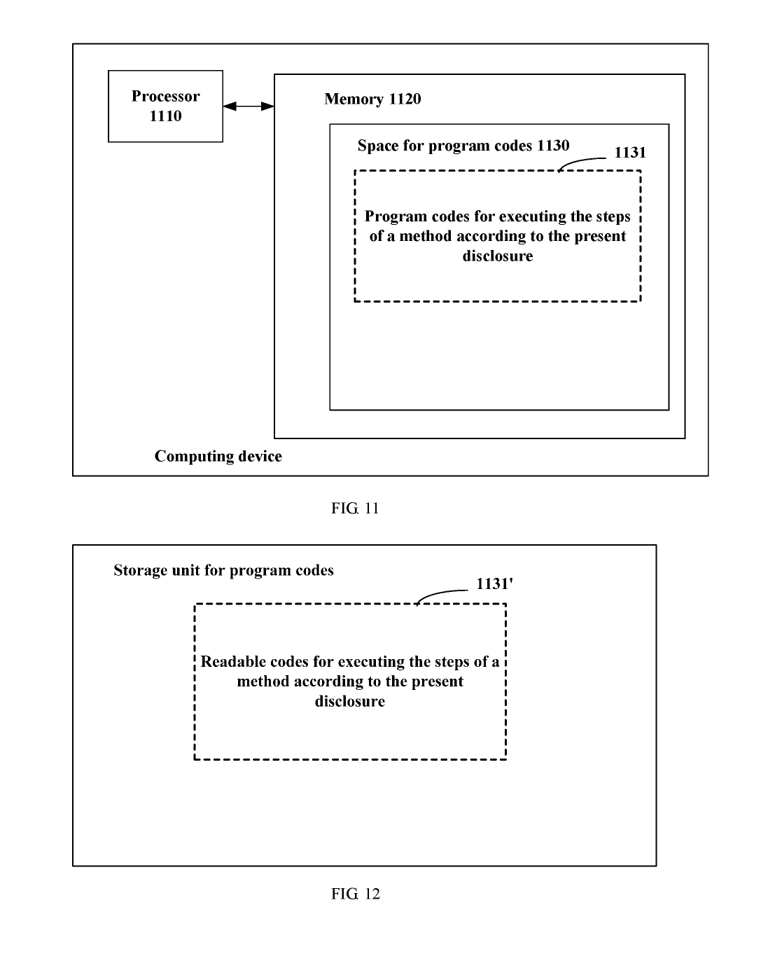

FIG. 11, illustrated is a computing device capable of implementing a video transcoding method according to the present disclosure. The computing device (e.g., a mobile terminal, a server, a monitored device) traditionally includes a processor 1110, and a module (program) product in the form of a memory 1120 or a readable medium. The memory 1120 may be an electronic memory, such as a flash memory, an EEPROM (Electrically-Erasable Programmable ROM), an EPROM, a hard disk or a ROM. The memory is provided with a storage space 1130 for program codes 1131 for executing any method steps in the above method. For example, the storage space 1130 for the program codes may include various program codes 1131 for separately implementing various steps in the above method. The program codes may be read out from one or more computer program products or written into the one or more computer program products. The computer program products include program code carriers such as a memory card. Such computer program products typically are portable or fixed storage units as shown in FIG. 12, which may have storage sections, storage spaces and the like arranged in a way similar to that of the memory 1120 in the computing device in FIG. 11. The program codes may be compressed in an appropriate form. Typically, the storage unit includes computer readable codes 1131′, namely codes that can be read by, for example, the processor 1110. When the processor of the computing device runs the codes, the processor of the computing device is led to execute various steps in the method described above.

Finally, it should be noted that the various above embodiments are merely used for illustrating, rather than limiting, the technical solutions of the present disclosure. Although the present disclosure is described in detail with reference to the various preceding embodiments, it should be appreciated by a person ordinarily skilled in the art that modifications can still be made to the technical solutions described in the various preceding embodiments, or equivalent substitutions can be made to part of or all technical features therein. The modifications or substitutions do not cause the nature of corresponding technical solutions to depart from the scope of the technical solutions of the various embodiments of the present disclosure.

What is claimed is:

1. A method for monitoring a door lock state, comprising:
searching for a door lock service provided by a server according to a door lock service identification code broadcasted by the server, wherein the door lock service identification code is in a corresponding relation to the door lock service;
establishing a Bluetooth connection corresponding to the door lock service with the server;
reading a door lock state record characteristic value corresponding to the door lock service by means of the Bluetooth connection according to the door lock service identification code, wherein the door lock state record characteristic value corresponding to the door lock service comprises open or closed.

2. The method according to claim 1, further comprising:
monitoring a distance to the server;
reading the door lock state record characteristic value corresponding to the door lock service when the distance is greater than a first threshold;
sending reminding information when the door lock state record characteristic value is open.

3. The method according to claim 1, further comprising:
monitoring signal strength of the Bluetooth connection, and determining path loss of the Bluetooth connection according to the signal strength;
reading the door lock state record characteristic value corresponding to the door lock service when the path loss is greater than a second threshold;
sending reminding information when the door lock state record characteristic value is open.

4. The method according to claim 1, wherein the step of reading the door lock state record characteristic value corresponding to the door lock service comprises the following step:
reading, in a polling way, the door lock state record characteristic value corresponding to the door lock service according to a first time period.

5. The method according to claim 2, further comprising:
executing a door lock closing operation by means of the Bluetooth connection according to a door closing operation executed by a user with regard to the reminding information, and modifying the door lock state record characteristic value corresponding to the door lock service to closed.

6. The method according to claim 4, further comprising:
searching for a vehicle window service provided by the server according to a vehicle window service identification code broadcasted by the server, wherein the vehicle window service identification code is in a corresponding relation to the vehicle window service;
reading a vehicle window state record characteristic value corresponding to the vehicle window service by means of the Bluetooth connection according to the vehicle window service identification code when the read door lock state record characteristic value corresponding to the door lock service is closed, wherein the vehicle window state record characteristic value corresponding to the vehicle window service comprises open or closed;
sending vehicle window reminding information when the vehicle window state record characteristic value is open.

7. The method according to claim 6, further comprising:
executing a vehicle window closing operation by means of the Bluetooth connection according to a window closing operation executed by a user with regard to the vehicle window reminding information, and modifying the vehicle window state record characteristic value corresponding to the vehicle window service to closed.

8. A method for monitoring a door lock state, comprising:
monitoring a real-time state of a door lock, and updating a door lock state record characteristic value corresponding to a door lock service according to the real-time state of the door lock;
broadcasting a door lock service identification code, wherein the door lock service identification code is in a corresponding relation to the door lock service;
establishing a Bluetooth connection corresponding to the door lock service with a client.

9. The method according to claim 8, wherein the step of monitoring the real-time state of the door lock, and updating the door lock state record characteristic value corresponding to the door lock service according to the real-time state of the door lock comprises:
monitoring the real-time state of the door lock, and updating the door lock state record characteristic value corresponding to the door lock service when the real-time state of the door lock is changed from open to closed, or from closed to open.

10. The method according to claim 8, further comprising:
sending the door lock state record characteristic value corresponding to the door lock service to the client by means of the Bluetooth connection according to a second time period.

11. The method according to claim 10, further comprising:
monitoring a real-time state of a vehicle window, and updating a vehicle window state record characteristic value corresponding to a vehicle window service according to the real-time state of the vehicle window;
broadcasting a vehicle window service identification code, wherein the vehicle window service identification code is in a corresponding relation to the vehicle window service.

12. A computing device for monitoring a door lock state, comprising:
at least one first processor; and
a first memory communicably connected with the at least one first processor for storing instructions executable by the at least one first processor, wherein execution of the instructions by the at least one first processor causes the at least one first processor to:
search for a door lock service provided by a server according to a door lock service identification code broadcasted by the server, wherein the door lock service identification code is in a corresponding relation to the door lock service;
establish a Bluetooth connection corresponding to the door lock service with the server; and
read a door lock state record characteristic value corresponding to the door lock service by means of the Bluetooth connection according to the door lock service identification code, wherein the door lock state record characteristic value corresponding to the door lock service comprises open or closed.

13. The computing device according to claim 12, wherein execution of the instructions by the at least one processor causes the at least one processor to further:
monitor a distance to the server;
read the door lock state record characteristic value corresponding to the door lock service when the distance is greater than a first threshold;
send reminding information when the door lock state record characteristic value is open.

14. The computing device according to claim 12, wherein execution of the instructions by the at least one processor causes the at least one processor to further:
monitor signal strength of the Bluetooth connection, and determine path loss of the Bluetooth connection according to the signal strength;
read the door lock state record characteristic value corresponding to the door lock service when the path loss is greater than a second threshold;
send reminding information when the door lock state record characteristic value is open.

15. The computing device according to claim 12, wherein read a door lock state record characteristic value corresponding to the door lock service by means of the Bluetooth connection according to the door lock service identification code comprises:
read, in a polling way, the door lock state record characteristic value corresponding to the door lock service according to a first time period.

16. The computing device according to claim 13, wherein execution of the instructions by the at least one processor causes the at least one processor to further:
execute a door lock closing operation by means of the Bluetooth connection according to a door closing operation executed by a user with regard to the reminding information, and modify the door lock state record characteristic value corresponding to the door lock service to closed.

17. The computing device according to claim 15, wherein execution of the instructions by the at least one processor causes the at least one processor to further:
search for a vehicle window service provided by the server according to a vehicle window service identification code broadcasted by the server, wherein the vehicle window service identification code is in a corresponding relation to the vehicle window service;
read a vehicle window state record characteristic value corresponding to the vehicle window service by means of the Bluetooth connection according to the vehicle window service identification code when the read door lock state record characteristic value corresponding to the door lock service is closed, wherein the vehicle window state record characteristic value corresponding to the vehicle window service comprises open or closed;
send vehicle window reminding information when the vehicle window state record characteristic value is open.

18. A computing device for monitoring a door lock state, comprising:
at least one second processor; and
a second memory communicably connected with the at least one second processor for storing instructions executable by the at least one second processor, wherein execution of the instructions by the at least one second processor causes the at least one second processor to:
monitor a real-time state of a door lock, and update a door lock state record characteristic value corresponding to a door lock service according to the real-time state of the door lock;
broadcast a door lock service identification code, wherein the door lock service identification code is in a corresponding relation to the door lock service;
establish a Bluetooth connection corresponding to the door lock service with a client.

19. The computing device according to claim 18, wherein monitor a real-time state of a door lock, and update a door lock state record characteristic value corresponding to a door lock service according to the real-time state of the door lock comprises:
monitor the real-time state of the door lock, and update the door lock state record characteristic value corresponding to the door lock service when the real-time state of the door lock is changed from open to closed, or from closed to open.

20. The computing device according to claim 19, wherein execution of the instructions by the at least one processor causes the at least one processor to further:
send the door lock state record characteristic value corresponding to the door lock service to the client by means of the Bluetooth connection according to a second time period.
